(19) United States
(12) Patent Application Publication
(10) Pub. No.: US 2024/0029944 A1
(43) Pub. Date: Jan. 25, 2024

(54) COIL COMPONENT

(71) Applicant: SAMSUNG ELECTRO-MECHANICS CO., LTD., Suwon-si (KR)

(72) Inventors: Sang Jin KIM, Suwon-si (KR); Boum Seock KIM, Suwon-si (KR); Han LEE, Suwon-si (KR); Byeong Cheol MOON, Suwon-si (KR); Jong Wook LEE, Suwon-si (KR); Jung Su HWANGBO, Suwon-si (KR); Jung Min PARK, Suwon-si (KR)

(73) Assignee: SAMSUNG ELECTRO-MECHANICS CO., LTD., Suwon-si (KR)

(21) Appl. No.: 18/133,628

(22) Filed: Apr. 12, 2023

(30) Foreign Application Priority Data
Jul. 20, 2022 (KR) 10-2022-0089663

(51) Int. Cl. H01F 27/29; H01F 17/04

(52) U.S. Cl. CPC H01F 27/292; H01F 17/041; H01F 2017/048

(57) ABSTRACT

A coil component includes a body, a coil disposed in the body, an external electrode disposed on one surface of the body and including at least one recess, and a via electrode disposed in the body and connecting the coil to the external electrode.

### CROSS-REFERENCE TO RELATED APPLICATION(S)

This application claims benefit of priority to Korean Patent Application No. 10-2022-0089663 filed on Jul. 20, 2022 in the Korean Intellectual Property Office, the disclosure of which is incorporated herein by reference in its entirety.

### TECHNICAL FIELD

The present disclosure relates to a coil component.

### BACKGROUND

An inductor, a coil component, is a passive electronic component used in electronic devices along with a resistor and a capacitor.

As electronic devices have been designed to have high-performance and a reduced size, the number of electronic components used in electronic devices has been increased and sizes thereof have been reduced.

Meanwhile, there has been demand for a coil component which may have a reduced thickness and handling between processes may be easily performed such that a defect rate may be reduced, and adhesion strength may be strengthened when mounted on a printed circuit board (PCB).

### SUMMARY

An aspect of the present disclosure is to provide a coil component which may have a reduced thickness and may have an external electrode only on a lower surface thereof while simplifying processes such that a defect rate between processes may decrease.

Another aspect of the present disclosure is to prevent a coil component from being moved or rotating by strengthening adhesion strength when a coil component is mounted on a PCB.

According to an aspect of the present disclosure, a coil component includes a body, a coil disposed in the body, an external electrode disposed on one surface of the body and including at least one recess, and a via electrode disposed in the body and connecting the coil to the external electrode.

### BRIEF DESCRIPTION OF DRAWINGS

The above and other aspects, features, and advantages of the present disclosure will be more clearly understood from the following detailed description, taken in conjunction with the accompanying lead-outs, in which:

FIG. 1 is a perspective diagram illustrating a coil component according to a first embodiment of the present disclosure;

FIG. 2 is an exploded diagram illustrating connection relationship between the components in FIG. 1;

FIG. 3 is a perspective diagram illustrating a lower portion of the coil component in FIG. 1;

FIG. 4 is a cross-sectional diagram taken along line I-I′ in FIG. 1;

FIG. 5 is a cross-sectional diagram taken along line II-II′ in FIG. 1;

FIG. 6 is a cross-sectional diagram taken along line III-III′ in FIG. 1;

FIG. 7 is a diagram illustrating the coil component in FIG. 1, viewed from below;

FIG. 8 is a perspective diagram illustrating a lower portion of a coil component according to a second embodiment of the present disclosure, similar to FIG. 3;

FIG. 9 is a cross-sectional diagram taken along line IV-IV′ in FIG. 8, similar to FIG. 6;

FIG. 10 is a diagram illustrating the coil component in FIG. 8, viewed from below, similar to FIG. 7; and

FIG. 11 is a diagram illustrating a coil component according to a third embodiment of the present disclosure, similar to FIG. 6.

### DETAILED DESCRIPTION

The terms used in the example embodiments are used to simply describe an example embodiment, and are not intended to limit the present disclosure. A singular term includes a plural form unless otherwise indicated. The terms, “include,” “comprise,” “may be configured to,” and the like, of the description are used to indicate the presence of features, numbers, steps, operations, elements, portions or combination thereof, and do not exclude the possibilities of combination or addition of one or more features, numbers, steps, operations, elements, portions or combination thereof. Also, the term “disposed on,” “disposed on,” and the like, may indicate that an element is disposed on or beneath an object, and may not necessarily mean that the element is disposed on the object with reference to a gravity direction.

Terms such as “coupled to,” “combined with,” and the like, may not only indicate that elements are directly and physically in contact with each other, but also include the configuration in which the other element is interposed between the elements such that the elements are also in contact with the other component.

The size and thickness of each component in the lead-outs may be arbitrarily indicated for ease of description, and thus, the present disclosure is not necessarily limited to the illustrated examples.

In the lead-outs, an L direction is a first direction or a length direction, a W direction is a second direction or a width direction, a T direction is a third direction or a thickness direction.

Hereinafter, a coil component according to an example embodiment will be described in detail with reference to the accompanying lead-outs, and in the description with reference to the accompanying lead-outs, the same or corresponding components may be provided with the same reference numerals and overlapping description thereof will not be provided.

In electronic devices, various types of electronic components may be used, and various types of coil components may be used between the electronic components to remove noise, or for other purposes.

In other words, in electronic devices, a coil component may be used as a power inductor, a high frequency inductor (HF inductor), a general bead, a high frequency bead (GHz bead), a common mode filter, and the like.

### First Embodiment

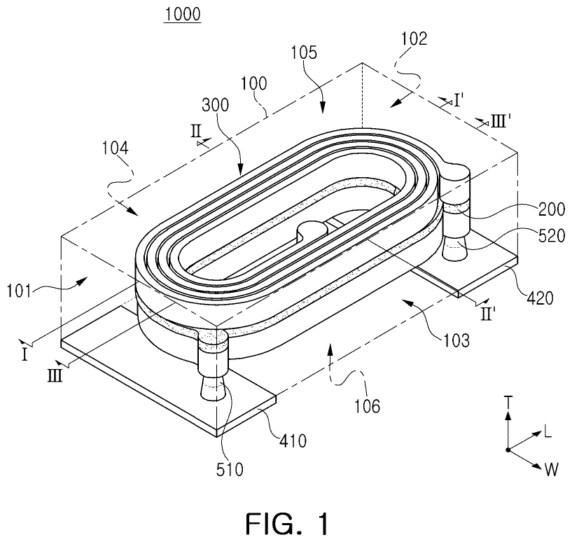

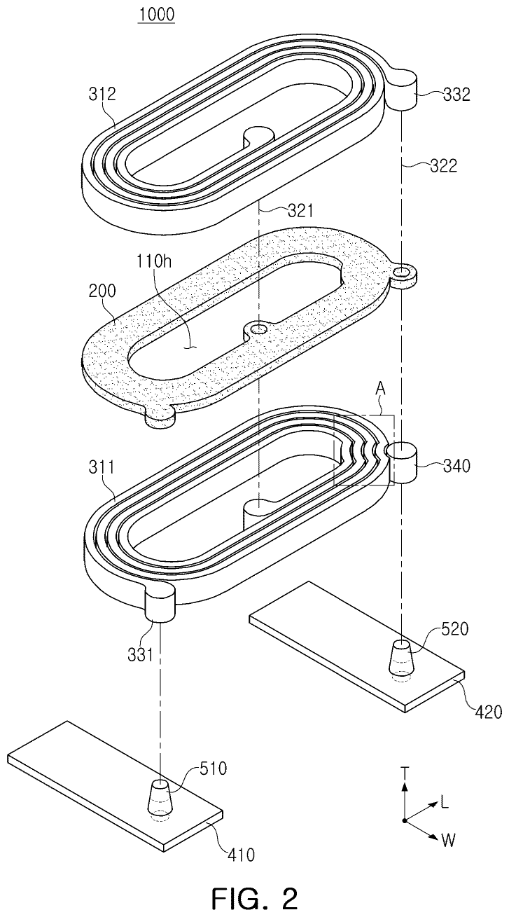

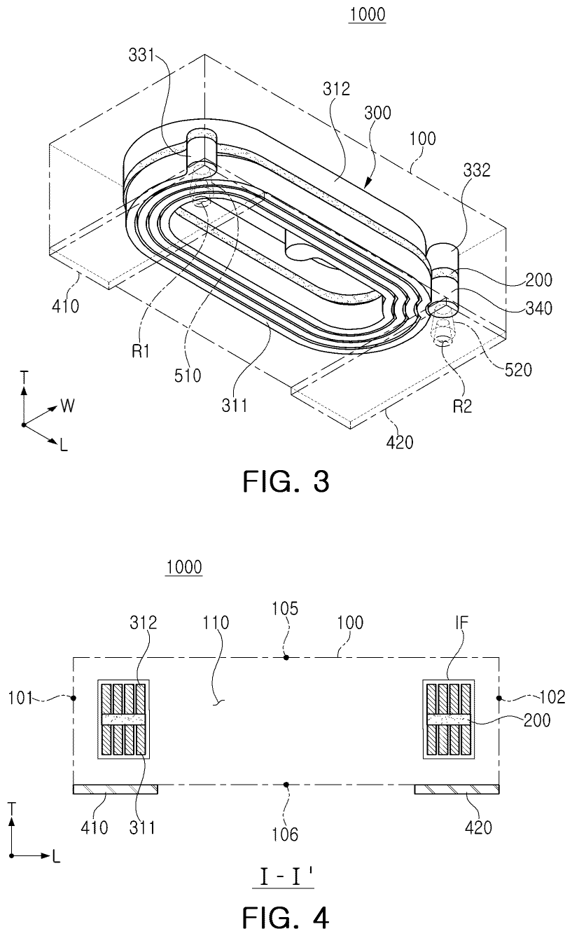

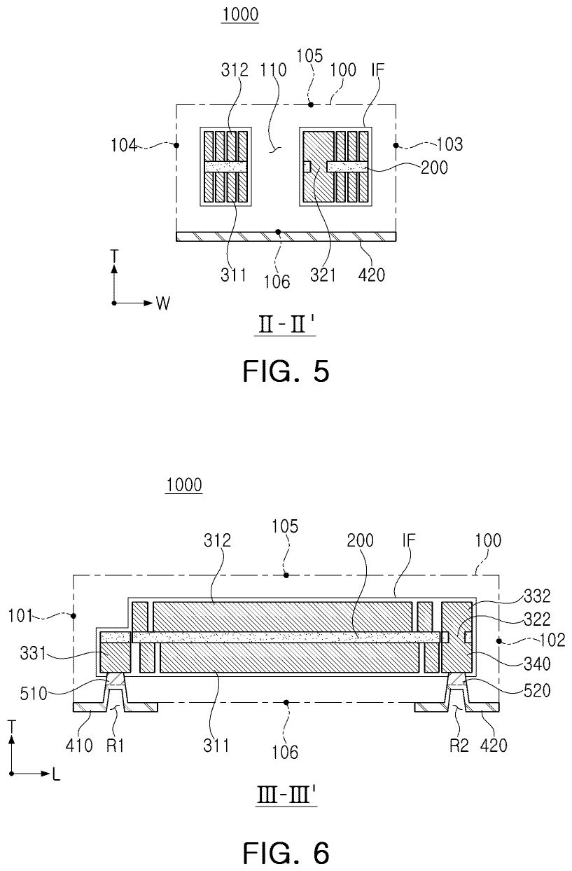

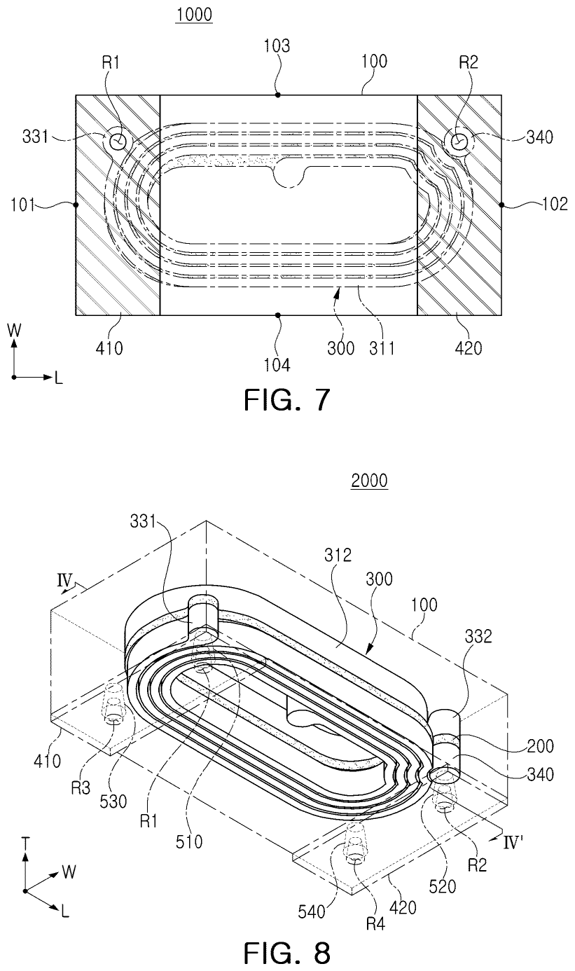

FIG. 1 is a perspective diagram illustrating a coil component 1000 according to a first embodiment. FIG. 2 is an exploded diagram illustrating connection relationship between the components in FIG. 1. FIG. 3 is a perspective diagram illustrating a lower portion of the coil component in FIG. 1. FIG. 4 is a cross-sectional diagram taken along line I-I′ in FIG. 1. FIG. 5 is a cross-sectional diagram taken along line II-II′ in FIG. 1. FIG. 6 is a cross-sectional diagram taken along line III-III′ in FIG. 1. FIG. 7 is a diagram illustrating the coil component in FIG. 1, viewed from below.

To more clearly illustrate the coupling between the components, the external insulating layer disposed on the body 100 applied to the example embodiment is not illustrated.

Referring to FIGS. 1 to 7, the coil component 1000 according to the first embodiment may include a body 100, a coil 300, external electrodes 410 and 420, and via electrodes 510 and 520, and may further include an insulating film IF.

The body 100 may form an exterior of the coil component 1000 in the example embodiment, and the coil 300 and the support member 200 may be disposed therein.

The body 100 may have a hexahedral shape.

The body 100 may include a first surface 101 and a second surface 102 opposing each other in the length direction L, a third surface 103 and a fourth surface 104 opposing each other in the width direction W, and a fifth surface 105 and a sixth surface 106 opposing each other in the thickness direction T, with respect to the directions in FIG. 1. Each of the first to fourth surfaces 101, 102, 103 and 104 of the body 100 may be a wall surface of the body 100 connecting the fifth surface 105 to the sixth surface 106 of the body 100. Hereinafter, both end surfaces (one end surface and the other end surface) of the body 100 may refer to the first surface 101 and the second surface 102 of the body 100, both side surfaces (one side surface and the other side surface) of the body 100 may refer to the third surface 103 and the fourth surface 104 of the body 100, and one surface and the other surface of the body 100 may refer to the sixth surface 106 and the fifth surface 105 of the body 100.

The body 100 may be formed such that the coil component in which the external electrodes 410 and 420 are formed may have a length of 2.5 mm, a width of 2.0 mm and a thickness of 1.0 mm, may have a length of 2.0 mm, a width of 1.2 mm and a thickness of 1.0 mm, may have a length of 2.0 mm, a width of 1.2 mm and a thickness of 0.65 mm, may a length of 1.6 mm, a width of 0.8 mm and a thickness of 0.8 mm, may have a length of 1.0 mm, a width of 0.5 mm and a thickness of 0.5 mm, may have a length of 1.0 mm, a width of mm and a thickness of 0.33 mm, or may have a length of mm, a width of 0.4 mm and a thickness of 0.65 mm, but an example embodiment thereof is not limited thereto. Since the above-described numerical value examples for the length, width, and thickness of the coil component 1000 do not reflect process errors, and a numerical value in a range recognized as a process error may correspond to the above-described numerical value examples.

The length of the above-described coil component 1000 may be a maximum value among dimensions of a plurality of line segments connecting two outermost boundary lines of the coil component 1000, opposing each other in the length direction L, to each other and in parallel to the length direction L, with respect to an optical microscope image or a scanning electron microscope (SEM) image with respect to a cross-section in the length direction L-thickness direction T taken from the central portion of the coil component 1000 taken in the width direction W. Alternatively, the length of the coil component 1000 may refer to a minimum value among the dimensions of the plurality of line segments connecting two outermost boundary lines of the coil component 1000, opposing each other in the length direction L, to each other and in parallel to the length direction L.

Alternatively, the length of the coil component 1000 may refer to an arithmetic mean value of at least three or more of the dimensions of the plurality of line segments described above. Here, the plurality of line segments parallel to the length direction L may be spaced apart from each other by an equal distance in the thickness direction T, but an example embodiment thereof is not limited thereto.

The thickness of the above-described coil component 1000 be a maximum value among dimensions of a plurality of line segments connecting two outermost boundary lines of the coil component 1000, opposing each other in the thickness direction T, to each other and in parallel to the thickness direction T, with respect to an optical microscope image or a scanning electron microscope (SEM) image with respect to a cross-section in the length direction L-thickness direction T taken from the central portion of the coil component 1000 taken in the width direction W. Alternatively, the length of the coil component 1000 may refer to a minimum value among the dimensions of the plurality of line segments connecting two outermost boundary lines of the coil component 1000, opposing each other in the length direction T, to each other and in parallel to the length direction T. Alternatively, the length of the coil component 1000 may refer to an arithmetic mean value of at least three or more of the dimensions of the plurality of line segments described above. Here, the plurality of line segments parallel to the thickness direction T may be spaced apart from each other by an equal distance in the thickness direction T, but an example embodiment thereof is not limited thereto.

The width of the above-described coil component 1000 may be a maximum value among dimensions of a plurality of line segments connecting two outermost boundary lines of the coil component 1000, opposing each other in the width direction W, to each other and in parallel to the width direction W, with respect to an optical microscope image or a scanning electron microscope (SEM) image with respect to a cross-section in the length direction L-width direction W taken from the central portion of the coil component 1000 taken in the thickness direction T. Alternatively, the width of the coil component 1000 may refer to a minimum value among the dimensions of the plurality of line segments connecting two outermost boundary lines of the coil component 1000, opposing each other in the width direction W, to each other and in parallel to the width direction W. Alternatively, the width of the coil component 1000 may refer to an arithmetic mean value of at least three or more of the dimensions of the plurality of line segments connecting two outermost boundary lines of the coil component 1000, opposing each other in the width direction W, to each other and in parallel to the width direction W. Here, the plurality of line segments parallel to the width direction W may be spaced apart from each other by an equal distance in the thickness direction T, but an example embodiment thereof is not limited thereto.

Alternatively, each of the length, width and thickness of the coil component 1000 may be measured by a micrometer measurement method. The micrometer measurement method may be of determining a zero point with a gage repeatability and reproducibility (R&R) micrometer, inserting the coil component 1000 in the example embodiment between tips of the micrometer, and measuring by turning a measuring lever of a micrometer. In measuring the length of the coil component 1000 by the micrometer measurement method, the length of the coil component 1000 may refer to a value measured once or may refer to an arithmetic average of values measured a plurality of times, which may be equally applied to the width and thickness of the coil component 1000.

Referring to FIGS. 3 and 6, a via hole in which via electrodes 510 and 520 are disposed may be formed in the sixth surface 106 of the body 100. The via hole may be formed in a pillar shape from the sixth surface 106 of the body 100 toward the internal region. The via hole may not penetrate the fifth surface 105 of the body 100 and may be formed up to a point at which the via hole is connected to the coil 300.

The via hole may be formed in a tapered shape in which a cross-sectional area thereof may gradually decrease toward the internal region of the body 100, but an example embodiment thereof is not limited thereto. The via hole may be formed in a cylindrical shape with a constant cross-sectional area.

The via hole may be formed using a laser, but an example embodiment thereof is not limited thereto, and may be formed by a generally used method for forming a hole.

The body 100 may include an insulating resin and a magnetic material. Specifically, the body 100 may be formed by laminating one or more magnetic composite sheets in which a magnetic material is dispersed in an insulating resin. The magnetic material may be ferrite or metallic magnetic powder.

A ferrite powder may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

Metal magnetic powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The metal magnetic powder may be amorphous or crystalline. For example, the magnetic metal powder may be a Fe—Si—B—Cr amorphous alloy powder, but an example embodiment thereof is not limited thereto.

Each particle of ferrite and magnetic metal powder may have an average diameter of about 0.1 μm to 30 μm, but an example embodiment thereof is not limited thereto.

The body 100 may include two or more types of magnetic materials dispersed in a resin. Here, the different types of magnetic materials may indicate that the magnetic materials dispersed in the resin may be distinguished from each other by one of an average diameter, composition, crystallinity, and shape.

In the description below, it will be assumed that the magnetic material is a magnetic metal powder, but an example embodiment thereof is not limited to the body 100 having a structure in which magnetic metal powder is dispersed in an insulating resin.

The insulating resin may include epoxy, polyimide, a liquid crystal polymer, or the like, alone or in combination but an example embodiment thereof is not limited thereto.

Referring to FIGS. 2, 4, and 5, the body 100 may include a core 110 penetrating through the support member 200 and the coil 300. The core 110 may be formed by filling a through-hole 110h through which a magnetic composite sheet including a magnetic material passes through the center of the coil 300 and the center of the support member 200, but an example embodiment thereof is not limited thereto.

The support member 200 may be disposed in the body 100. The support member 200 may be configured to support the coil 300. The support member 200 may not be provided depending on embodiments, such as when the coil 300 is configured to be a wound coil or has a coreless structure.

The support member 200 may be formed of a thermosetting insulating resin such as an epoxy resin, a thermoplastic insulating resin such as polyimide, or an insulating material including a photosensitive insulating resin, or an insulating material in which the insulating resin is impregnated with a reinforcing material such as glass fiber or inorganic filler. For example, the support member 200 may be formed of an insulating material such as prepreg, Ajinomoto build-up film (ABF), FR-4, bismaleimide triazine (BT) film, and photo imaginable dielectric (PID) film, but an example embodiment thereof is not limited thereto.

As inorganic fillers, at least one selected from a group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃) may be used.

When the support member 200 is formed of an insulating material including a reinforcing material, the support member 200 may provide excellent rigidity. When the support member 200 is formed of an insulating material that does not include glass fibers, it may be advantageous to reduce the thickness of the coil component 1000 according to the example embodiment. Also, with respect to the body 100 of the same size, the volume occupied by the coil 300 and/or the magnetic metal powder may be increased, thereby improving component properties. When the support member 200 is formed of an insulating material including a photosensitive insulating resin, the number of processes for forming the coil 300 may be reduced, which is advantageous in reducing production costs, and fine vias 321 and 322 may be formed.

The thickness of the support member 200 may be, for example, 10 μm or more and 50 μm or less, but an example embodiment thereof is not limited thereto.

The coil 300 may be disposed in the body 100, and may exhibit properties of the coil component 1000. For example, when the coil component 1000 of the example embodiment is used as a power inductor, the coil 300 may maintain an output voltage by storing an electric field as a magnetic field, thereby stabilizing the power of the electronic device.

The coil component 1000 according to the example embodiment may include a coil 300 supported by the support member 200 in the body 100. The coil 300 may form a turn around the core 110.

Referring to FIGS. 1, 4, and 6, the coil 300 may include first and second coil patterns 311 and 312, a first via 321, and first and second lead-out pads 331 and 332, and may further include a connection pad 340 and a second via 322.

Specifically, with respect to the direction in FIG. 1, the first coil pattern 311, the first lead-out pad 331, and the connection pad 340 may be disposed on one surface of the support member 200 opposing the sixth surface 106 of the body 100, and the second coil pattern 312 and the second lead-out pad 332 may be disposed on the other surface of the support member 200 opposing the fifth surface 105 of the body 100.

Referring to FIGS. 2 and 4 to 5, each of the first coil pattern 311 and the second coil pattern 312 may have at least one turn about the core 110 as an axis. Each of the first coil pattern 311 and the second coil pattern 312 may have a planar spiral shape.

The first coil pattern 311 may form at least one turn about the core 110 as an axis on one surface of the support member 200. The second coil pattern 312 may form at least one turn about the core 110 as an axis on the other surface of the support member 200.

Referring to FIGS. 2 and 5, the coil 300 may include the via 321 penetrating through the support member 200 and connecting the first and second coil patterns 311 and 312 on both sides of the support member 200 to each other.

The via 321 may electrically connect the first and second coil patterns 311 and 312 disposed on both surfaces of the support member 200 to each other. Specifically, with respect to the direction in FIG. 1, the lower surface of the first via 321 may be connected to the end of the innermost turn of the first coil pattern 311, and the upper surface of the first via 321 may be connected to the end of the innermost turn of the second coil pattern 312.

Here, a maximum line width of the inner ends of the first and second coil patterns 311 and 312 connected to the first via 321 may be configured to be wider than the line width of the other regions. That is, the inner ends of the first and second coil patterns 311 and 312 may have a pad shape. Through the above structure, even when the line widths of the coil patterns 311 and 312 are configured to be relatively narrow to improve inductance properties in the miniaturized coil component 1000, connection reliability between the coil patterns 311 and 312 and the first via 321 may improve. However, an example embodiment thereof is not limited thereto, and in the case in which the line width of the coil patterns 311 and 312 is sufficiently wide as compared to the cross-sectional area of the first via 321, the inner ends of the coil patterns 311 and 312 may also have a uniform line width.

Referring to FIGS. 2 and 6, the coil 300 may include first and second lead-out pads 331 and 332 connected to the ends of the outermost turns of the first and second coil patterns 311 and 312.

The first and second lead-out pads 331 and 332 may be disposed in the body 100 and may not be exposed to the external side surface of the body 100. The first and second lead-out pads 331 and 332 may be connected to first and second via electrodes 510 and 520, respectively.

Specifically, referring to FIG. 2, the first lead-out pad 331 may be directly connected to the first via electrode 510, the second lead-out pad 332 may be disposed on the upper surface of the support member 200 such that the second lead-out pad 332 may be connected to the connection pad 340 through the second via 322, and as the connection pad 340 is connected to the second via electrode 520, the second lead-out pad 332 and the second via electrode 520 may be electrically connected to each other.

The connection pad 340 may be disposed to be spaced apart from the first coil pattern 311 on one surface of the support member 200, and the upper surface thereof may be connected to the lead-out pad 332 through the second via 322 penetrating through the support member 200, and lower surface thereof may be connected to the second via electrode 520.

Meanwhile, in the case in which the second via electrode 520 extends and is directly connected to the second via 322, the connection pad 340 may not be provided.

Referring to region A in FIG. 2, in the example embodiment, the first coil pattern 311 may be formed such that a region thereof adjacent to the connection pad 340 may be curved toward the center of the first coil pattern 311. This structure may be configured to improve inductance properties by separating the first coil pattern 311 and the connection pad 340 in the miniaturized coil component 1000 and maximally widening the area of the core 110. Accordingly, in the case in which the space in the body 100 is sufficient, the first coil pattern 311 may be formed in the same shape as that of the second coil pattern 312 without the curved region (region A).

Here, the maximum line width of the lead-out pads 331 and 332 and the connection pad 340 may be configured to be wider than the line width of the coil patterns 311 and 312. That is, the lead-out pads 331 and 332 and the connection pad 340 may have a pad shape. Through this structure, even when the line widths of the coil patterns 311 and 312 are configured to be narrow to improve inductance properties in the miniaturized coil component 1000, alignment may be facilitated when the via electrodes 510 and 520 are connected, and connection reliability between the first lead-out pad 331 and the first via electrode 510 and between the connection pad 340 and the second via electrode 520 may improve. Also, connection reliability between the second lead-out pad 332 and the second via 322 may also improve.

However, an example embodiment thereof is not limited thereto, and in the case in which the line width of the coil patterns 311 and 312 is sufficiently wide as compared to the cross-sectional area of the upper surface of the second via 321 or the via electrode 510 and 520, the lead-out pads 331 and 332 may also have the same line width as that of the coil patterns 311 and 312.

Referring to FIG. 2, the first lead-out pad 331 may extend from the end of the outermost turn of the first coil pattern 311 and may be connected to the first via electrode 510, and the first via electrode 510 may be connected to the first external electrode 410. Also, the second lead-out pad 332 may extend from the end of the outermost turn of the second coil pattern 312 and may be connected to the second via electrode 520 through the second via 322 and the connection pad 340, and the second via electrode 520 may be connected to the second external electrode 420. Also, inner ends of the first and second coil patterns 311 and 312 may be connected through the first via 321.

Through this structure, the input from the first external electrode 410 may pass through the first via electrode 510, the first lead-out pad 331, the first coil pattern 311, the first via 321, the second coil pattern 312, the second lead-out pad 332, the second via 322, the connection pad 340, and the second via electrode 520 in sequence and may be output through the second external electrode 420.

Accordingly, the coil 300 may function as a single coil between the first and second external electrodes 410 and 420.

At least one of the first and second coil patterns 311 and 312, the first and second vias 321 and 322, the first and second lead-out pads 331 and 332, and the connection pad 340 may include at least one conductive layer.

As an example, referring to FIGS. 4 to 6, when the first coil pattern 311, the first and second vias 321 and 322, the first lead-out pad 331, and the connection pad 340 are formed on one surface of the support member 200, each of the first coil pattern 311, the first and second vias 321 and 322, the first lead-out pad 331, and the connection pad 340 may include a seed layer and an electroplating layer. Here, the electroplating layer may have a monolayer structure or a multilayer structure. The electrolytic plating layer having a multilayer structure may be formed in a conformal film structure in which an electroplating layer is formed along the surface of the other electroplating layer, or an electroplating layer may be laminated only on the other surface of one electroplating layer. The seed layer may be formed by an electroless plating method or a vapor deposition method such as sputtering. The seed layers of the first coil pattern 311, the first and second vias 321 and 322, the first lead-out pad 331, and the connection pad 340 may be integrally formed such that no boundary may be formed therebetween. However, an example embodiment thereof is not limited thereto. The electroplating layers of the first coil pattern 311, the first and second vias 321 and 322, the first lead-out pad 331, and the connection pads 340 may be integrally formed such that no boundary may be formed therebetween. However, an example embodiment thereof is not limited thereto.

Each of the first and second coil patterns 311 and 312, the first and second vias 321 and 322, the first and second lead-out pads 331 and 332, and the connection pad 340 may be formed of a conductive material such as copper (Cu), aluminum (Al), silver (Ag), tin (Sn), gold (Au), nickel (Ni), lead (Pb), titanium (Ti), chromium (Cr), or alloys thereof, but an example embodiment thereof is not limited thereto.

Referring to FIGS. 4 to 6, the coil component 1000 according to the example embodiment may further include an insulating film IF. The insulating film IF may integrally cover the coil 300 and the support member 200.

Specifically, the insulating film IF may be disposed between the coil 300 and the body 100 and between the support member 200 and the body 100. The insulating film IF may be formed along the surface of the support member 200 on which the first and second coil patterns 311 and 312 and the first and second lead-out pads 331 and 332 are disposed, but an example embodiment thereof is not limited thereto.

The insulating film IF may fill regions between adjacent turns of the first and second coil patterns 311 and 312, and between the first and second lead-out pads 331 and 332 and the first and second coil patterns 311 and 312, respectively, and may insulate the coil turns from each other.

The insulating film IF may be provided to insulate the coil 300 from the body 100, and may include a well-known insulating material such as parylene, but an example embodiment thereof is not limited thereto. As another example, the insulating film IF may include an insulating material such as an epoxy resin other than parylene. The insulating film IF may be formed by vapor deposition, but an example embodiment thereof is not limited thereto. As another example, the insulating film IF may be formed by laminating and curing an insulating film on the support member 200 on which the coil 300 is disposed, or may be formed by coating and curing an insulating paste on both surfaces of the support member 200 on which the coil 300 is disposed. Accordingly, the insulating film IF may not be provided in the example embodiment. That is, in the case in which the body 100 has sufficient electrical resistance at the designed operating current and voltage of the coil component 1000 according to the example embodiment, the insulating film IF may not be provided in the example embodiment.

Referring to FIGS. 1 to 3 and 6, the first and second external electrodes 410 and 420 may be spaced apart from each other on the body 100 and may be electrically connected to the coil 300. Specifically, the first external electrode 410 may be disposed on the sixth surface 106 of the body 100, and may be electrically connected to the first lead-out pad 331 through the first via electrode 510. Also, the second external electrode 420 may be disposed on the sixth surface 106 of the body 100 to be spaced apart from the first external electrode 410, and may be connected to the connection pad 340 through the second via electrode 520.

As such, since the external electrodes 410 and 420 are disposed only on the sixth surface 106 of the body 100, a short circuit with adjacent components may be prevented when the coil component 1000 is mounted on the PCB, and the volume of the body 100 may be increased within the same size, which may be advantageous for miniaturization.

Referring to FIGS. 3 and 6 to 7, the external electrodes 410 and 420 may include at least one recess R1 and R2. In example embodiments, the recesses R1 and R2 may refer to a region of the external electrodes 410 and 420 which may be concavely recessed toward the internal region of the body 100.

The recesses R1 and R2 may be formed in regions corresponding to the lower portions of the via electrodes 510 and 520 among the external electrodes 410 and 420 when the via electrodes 510 and 520 are formed.

When the coil component 1000 is mounted on the PCB, the recesses R1 and R2 may be filled with solder such that the contact area between the external electrodes 410 and 420 and the solder may increase, and accordingly, adhesion strength between the coil component 1000 and the PCB may be strengthened, and defects in which the coil component 1000 moves and rotates may be reduced.

Referring to FIG. 6, the external electrodes 410 and 420 may include an internal side surface opposing the body 100 and an external side surface opposing the internal side surface, and at least one of the recesses R1 and R2 may be formed in a region of the external side surface of the external electrodes 410 and 420 in which the internal side surface of the external electrodes 410 and 420 is in contact with the via electrodes 510 and 520. That is, referring to FIG. 6, when the boundary between the external electrodes 410 and 420 and the via electrodes 510 and 520 is indicated by a dotted line, the recesses R1 and R2 may be formed in the region below the dotted line.

Referring to FIGS. 3, 6, and 7, the recesses R1 and R2 may be formed in a shape in which the cross-sectional area thereof may decrease from the external side to the internal side of the external electrodes 410 and 420. As the recesses R1 and R2 have a tapered shape as described above, solder may be easily filled in the recesses R1 and R2 when the coil component 1000 is mounted on a PCB as compared to the example in which the cross-sectional area is constant, and the contact area between the solder and the external electrodes 410 and 420 may also be increased.

Meanwhile, in the example embodiment, the recesses R1 and R2 may have a tapered cylindrical shape, but an example embodiment thereof is not limited thereto, and the cross-sectional area may have various shapes such as a constant cylindrical shape or an irregularly recessed shape.

The external electrodes 410 and 420 may be formed by a vapor deposition method such as sputtering and/or a plating method, but an example embodiment thereof is not limited thereto.

The external electrodes 410 and 420 may be formed of a conductive material such as copper (Cu), aluminum (Al), silver (Ag), tin (Sn), gold (Au), nickel (Ni), lead (Pb), chromium (Cr), titanium (Ti), or alloys thereof, but an example embodiment thereof is not limited thereto.

The external electrodes 410 and 420 may be formed in a monolayer structure or multilayer structure. For example, the external electrodes 400 and 500 may include a first conductive layer including copper (Cu), a second conductive layer disposed on the first conductive layer and including nickel (Ni), and a third conductive layer disposed on the second conductive layer and including tin (Sn). At least one of the second conductive layer and the third conductive layer may be configured to cover the first conductive layer, but an example embodiment thereof is not limited thereto. The first conductive layer may be a plating layer or a conductive resin layer formed by coating and curing a conductive resin including a conductive powder including at least one of copper (Cu) and silver (Ag) and a resin. The second and third conductive layers may be configured as plating layers, but an example embodiment thereof is not limited thereto.

Referring to FIGS. 1 to 3 and 6, the coil component 1000 according to the example embodiment may include via electrodes 510 and 520 disposed in the body 100 and connecting the coil 300 to the external electrodes 410 and 420. Specifically, the coil component 1000 according to the example embodiment may include a first via electrode 510 connecting the first lead-out pad 331 to the first external electrode 410, and a second via electrode 520 connecting the second lead-out pad 332 to the second external electrode 420. In the example embodiment, the second lead-out pad 332 and the second via electrode 520 may be electrically connected to each other through the connection pad 340 and the second via 322.

The via electrodes 510 and 520 may be integrally formed without a boundary surface with the external electrodes 410 and 420, but for ease of description, in example embodiments, the regions of the via electrodes 510 and 520 may be distinct from the external electrodes 410 and 420. Referring to FIG. 6, the external electrodes 410 and 420 in which the recesses R1 and R2 are formed and the via electrodes 510 and 520 disposed above the recesses R1 and R2 are indicated by a dotted line, a conceptual boundary line.

Since the via electrodes 510 and 520 directly connect the coil 300 to the external electrodes 410 and 420 in the body 100, the external electrodes 410 and 420 may be disposed only on the sixth surface 106 of the body 100 such that the coil component 1000 advantageous for integration may be implemented. Also, as compared to the example in which the coil 300 and the external electrodes 410 and 420 are connected to each other on the external side surface of the body 100 when the lower electrode is implemented, dicing, polishing, and insulation processes may be simplified, thereby increasing production efficiency and reducing a defect rate between processes.

Referring to FIGS. 2 and 6, the via electrodes 510 and 520 may be formed such that the cross-sectional area thereof may decrease from the external side to the internal side of the body 100. That is, the via electrodes 510 and 520 may be formed in a tapered shape.

The via electrodes 510 and 520 may be formed by processing via holes in the sixth surface 106 side of the body 100 after forming the body 100, and filling the via hole with a conductive material in the plating process for forming the external electrodes 410 and 420. In this case, the external electrodes 410 and 420 and the via electrodes 510 and 520 may be integrally formed. That is, since the external electrodes 410 and 420 and the via electrodes 510 and 520 may be formed in the same process, such that boundary surfaces therebetween may not appear.

In the case of using a laser for processing a via hole, the cross-sectional area of the region in which the laser starts irradiating may be configured to be wider than the innermost region of the via hole, and accordingly, the via electrodes 510 and 520 may be formed in a tapered shape. However, an example embodiment thereof is not limited thereto, and the via electrodes 510 and 520 may be formed in a cylindrical shape or an irregular shape having a constant cross-sectional area.

The via electrodes 510 and 520 may include a seed layer formed on the internal surface of the via hole, but an example embodiment thereof is not limited thereto. That is, in the case in which the magnetic metal powder included in the body 100 has sufficient conductivity at the plating current and voltage during electroplating, a seed layer may not be formed.

Referring to FIGS. 1, 3, and 7, the via electrodes 510 and 520 may be disposed more adjacent (nearer) to the third surface 103 than the fourth surface 104 of the body 100. Accordingly, the recesses R1 and R2 disposed below the via electrodes 510 and 520 may also be disposed more adjacent (nearer) to the third surface 103 than the fourth surface 104 of the body 100.

The via electrodes 510 and 520 are disposed to be more adjacent (nearer) to the third surface 103 than the fourth surface 104 of the body 100 in the edge regions formed by the first surface 101 and the third surface 103 and the second surface 102 and the third surface 103 of the body 100, the space in which the coil patterns 311 and 312 are expanded in the body 100 may be secured. Accordingly, the volume of the core 110 disposed in the center of the coil patterns 311 and 312 may increase, such that inductance properties of the coil component 1000 may improve.

The via electrodes 510 and 520 may be formed by a plating method, but an example embodiment thereof is not limited thereto.

The via electrodes 510 and 520 may be formed of a conductive material such as copper (Cu), aluminum (Al), silver (Ag), tin (Sn), gold (Au), nickel (Ni), lead (Pb), chromium (Cr), titanium (Ti), or alloys thereof, but an example embodiment thereof is not limited thereto.

The via electrodes 510 and 520 may be configured together in the same process of forming the external electrodes 410 and 420 and the via electrodes 510 and 520 may be integrated with the external electrodes 410 and 420 without a boundary therebetween, but an example embodiment thereof is not limited thereto.

The coil component 1000 according to the example embodiment may further include an external insulating layer disposed in the region in which the external electrodes 410 and 420 are not disposed among the first to fifth surfaces 101, 102, 103, 104, 105, and the sixth surface 106 of the body 100.

At least a portion of the external insulating layers disposed on the first to sixth surfaces 101, 102, 103, 104, 105, and 106 of the body 100, respectively, may be formed in the same process, such that the external insulating layers may be integrated with each other without a boundary therebetween, but an example embodiment thereof is not limited thereto.

The external insulating layer may be formed by a method such as a printing method, a vapor deposition method, a spray coating method, or a film lamination method, using an insulating material, but an example embodiment thereof is not limited thereto.

The external insulating layer may include a thermoplastic resin such as polystyrene resin, vinyl acetate resin, polyester resin, polyethylene resin, polypropylene resin, polyamide resin, rubber resin, acrylic resin, a thermosetting resin such as phenolic resin, epoxy resin, urethane resin, melamine resin, and alkyd resin, a photosensitive resin, parylene, SiOₓ, or SiNₓ. The outer insulating layer may further include an insulating filler such as an inorganic filler, but an example embodiment thereof is not limited thereto.

### Second Embodiment

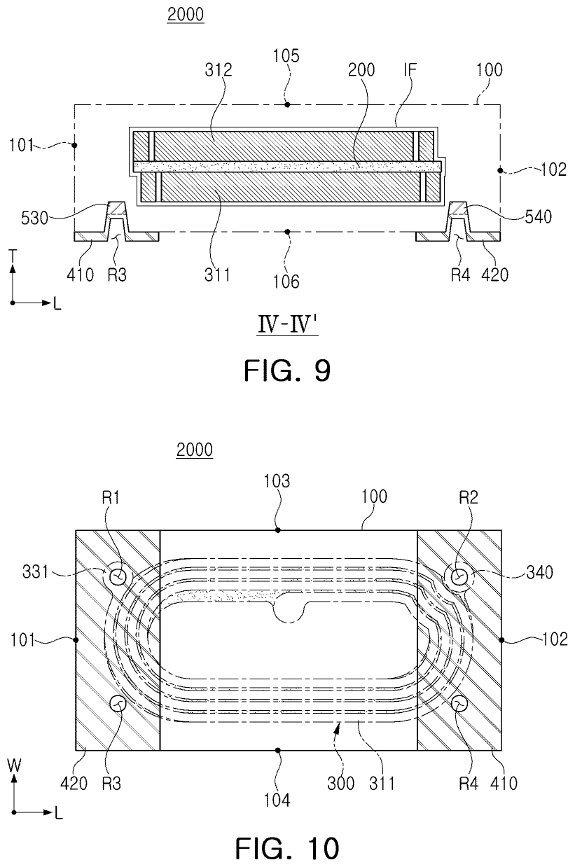

FIG. 8 is a perspective diagram illustrating a lower portion of a coil component 2000 according to a second embodiment, similar to FIG. 3. FIG. 9 is a cross-sectional diagram taken along line IV-IV′ in FIG. 8, similar to FIG. 6. FIG. 10 is a diagram illustrating the coil component in FIG. 8, viewed from below, similar to FIG. 7.

Referring to FIGS. 8 to 10, the coil component 2000 according to the second embodiment may be different from the coil component 1000 according to the first embodiment in that the coil component 2000 may further include pole portions 530 and 540 such that recesses R3 and R4 may be further formed in the external electrodes 410 and 420.

Therefore, in describing the example embodiment, only the pole portions 530 and 540 and the additional recesses R3 and R4 different from the first embodiment will be described. For the rest of the components of the example embodiment, the description in the first embodiment may be applied as is.

Referring to FIGS. 8 to 10, the coil component 2000 according to the example embodiment may include pole portions 530 and 540 disposed in the body 100, connected to the external electrodes 410 and 420, and spaced apart from the coil 300 and the via electrode 510 and 520, respectively. Also, the coil component 2000 according to the example embodiment may include recesses R3 and R4 disposed in lower regions of the pole portions 530 and 540.

The pole portions 530 and 540 may not be connected to the coil 300 and may thus be irrelevant to the flow of current in the coil component 2000, and the recesses R3 and R4 may be formed in the lower regions of the pole portions 530 and 540 such that adhesion strength may be strengthened when the coil component 2000 is mounted on the PCB.

The pole portions 530 and 540 may be integrally formed with the external electrodes 410 and 420 without a boundary surface therebetween, but for ease of description, in example embodiments, the regions of the pole portions 530 and 540 may be distinct from the regions of the external electrodes 410 and 420. Referring to FIG. 9, the external electrodes 410 and 420 in which the recesses R3 and R4 are formed may be distinct from the pole portions 530 and 540 disposed above the recesses R3 and R4 by a dotted line, a conceptual boundary line.

Referring to FIG. 8, the pole portions 530 and 540 may be spaced apart from the via electrodes 510 and 520 in the width direction W. Specifically, the first pole portion 530 may be disposed in a position corresponding to the first via electrode 510 connected to the first external electrode 410 and spaced apart in the width direction W. Also, the second pole portion 540 may be disposed in a position corresponding to the second via electrode 520 connected to the second external electrode 420 and spaced apart in the width direction W.

Referring to FIG. 9, the pole portions 530 and 540 may be spaced apart from the coil 300. The pole portions 530 and 540 may be formed such that a cross-sectional area thereof may decrease from the external side to the internal side of the body 100. That is, the pole portions 530 and 540 may be formed in a tapered shape.

The pole portions 530 and 540 may be formed by processing a via hole in the sixth surface 106 side of the body 100 after forming the body 100, and filling the via hole with a conductive material in the plating process for forming the external electrodes 410 and 420. In this case, the external electrodes 410 and 420 and the pole portions 530 and 540 may be integrally formed. That is, the external electrodes 410 and 420 and the pole portions 530 and 540 may be formed in the same process, such that a boundary surface therebetween may not appear.

When a laser is used for processing a via hole, since the cross-sectional area of the region in which the laser starts irradiating may be configured to be wider than the innermost region of the via hole, the pole portions 530 and 540 may be formed to have a tapered shape. However, an example embodiment thereof is not limited thereto, and the pole portions 530 and 540 may be formed in a cylindrical shape or an irregular shape having a constant cross-sectional area.

The pole portions 530 and 540 may include a seed layer formed on the internal surface of the via hole, but an example embodiment thereof is not limited thereto. That is, in the case in which the magnetic metal powder included in the body 100 has sufficient conductivity at the plating current and voltage during electroplating, a seed layer may not be formed.

The pole portions 530 and 540 in the example embodiment may be formed to have an area and a depth similar to those of the via electrodes 510 and 520. In this case, the laser output, irradiation angle, time, and the like, in a process such as via hole processing may be maintained to be constant, such that process efficiency may be increased. However, an example embodiment thereof is not limited thereto, and the area and depth of the pole portions 530 and 540 may be formed differently from those of the via electrodes 510 and 520, and only one of the first and second pole portions 530 and 540 may be formed.

Referring to FIGS. 8 to 10, the coil component 2000 according to the example embodiment may include additional recesses R3 and R4 as compared to the first embodiment. At least one of the recesses R3 and R4 may be formed in a region opposing the region of the external side surface of the external electrodes 410 and 420 in which the internal side surfaces of the external electrodes 410 and 420 are in contact with the pole portions 530 and 540. That is, referring to FIG. 9, when the boundary between the external electrodes 410 and 420 and the pole portions 530 and 540 is indicated by a dotted line, the recesses R3 and R4 may be formed below the dotted line.

As compared to the first embodiment, in the coil component 2000 of the example embodiment, as the number of recesses R1, R2, R3, and R4 formed in the external electrodes 410 and 420 increases, such that contact area with solder may increase when being mounted on the PCB, and accordingly, adhesion strength may be strengthened, and as the recesses R1, R2, R3, and R4 are symmetrically formed in the edges, the effect of preventing the coil component 2000 from being moved or rotating may further improve.

### Third Embodiment

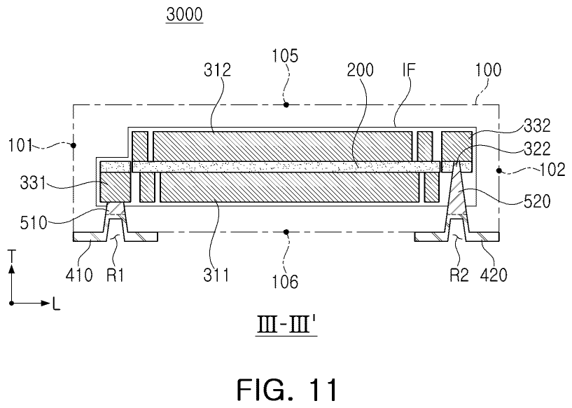

FIG. 11 is a diagram illustrating a coil component 3000 according to a third embodiment, similar to FIG. 6.

Referring to FIG. 11, the coil component 3000 according to the third embodiment may be different from the coil component 1000 according to the first embodiment in that the connection pad 340 is not provided in the coil component 3000, and the shape of the second via electrode 520 and connection relationship with the second coil pattern 312 may be different in the coil component 3000.

Therefore, in describing the example embodiment, only the shape of the second via electrode 520 and the connection relationship with the second coil pattern 312, which are different from those of the first embodiment, will be described. For the rest of the components of the example embodiment, the description in the first embodiment may be applied as is.

Referring to FIG. 11, the second via electrode 520 may penetrate through the support member 200 and may be connected to the second lead-out pad 332. Specifically, when forming a via hole for disposing the second via electrode 520, the second via electrode 520 may be formed more deeply than the first via electrode 510 by adjusting the laser output, irradiation angle, irradiation time, and the like.

In the example embodiment, the second lead-out pad 332 may be directly connected to the second external electrode 420 only using the second via electrode 520 without forming the connection pad 340, and the second via 322 may also be formed in the same process.

The second via 322 may be integrally formed with the second via electrode 520, and may be configured to have a smaller diameter than in the first embodiment. In this case, alignment for connecting the second lead-out pad 332 to the second via 322 may be more easily performed.

In the coil component 3000 according to the example embodiment, since the process of forming the connection pad 340 and the second via 322 may not be performed, process efficiency may be increased and the defect rate between processes may be reduced. Also, since a portion of the volume occupied by the connection pad 340 in the first embodiment may be further filled with a magnetic material, inductance properties may improve.

### Effect from Formation of Recesses

TABLE 1

| Experimental | Adhesion strength | Adhesion strength |
|---|---|---|
| example | without recess (N) | with recess (N) |
| #1 | 5.833 | 8.944 |
| #2 | 10.150 | 10.952 |
| #3 | 5.680 | 11.785 |
| #4 | 10.700 | 6.661 |
| #5 | 9.825 | 7.161 |
| #6 | 5.189 | 8.350 |
| #7 | 5.132 | 6.915 |
| #8 | 6.511 | 9.262 |
| #9 | 9.865 | 10.451 |
| #10 | 5.975 | 8.510 |
| #11 | 5.683 | 9.665 |
| #12 | 9.186 | 9.698 |
| #13 | 5.367 | 9.740 |
| #14 | 10.422 | 10.227 |
| #15 | 9.676 | 9.627 |
| #16 | 8.658 | 12.230 |
| #17 | 10.368 | 8.758 |
| #18 | 10.320 | 8.201 |
| #19 | 5.909 | 8.844 |
| #20 | 5.120 | 13.750 |
| Average value | 7.778 | 9.487 |
| Minimum value | 5.120 | 6.661 |
| Maximum value | 10.700 | 13.750 |
| Standard deviation | 2.256 | 1.777 |
| Change rate | — | 21.97% |

Table 1 pertains to the measurement data of adhesion strength depending on the presence or absence of the recesses R1 and R2 formed in the external electrodes 410 and 420.

The samples used for the measurement were 20 coil portions having a length of 1.0 mm, a width of 0.5 mm, and a thickness of 0.33 mm, and adhesion strength with the PCB when a single recess was formed in each external electrode was measured. (Specification of laser used to form via hole: Rep. rate 4.5 kHz, duty 7%, AOM diffraction efficiency 130, power 39.1 W, and aperture 3.5)

A via hole having a taper shape of a depth of 55 μm to 65 μm was processed using the laser of the above specification, and the via electrodes 510 and 520 and the recesses R1 and R2 were formed through plating, and thereafter, adhesion strength was measured.

When measuring adhesion strength, a substrate of FR-4 material having a length of 100 mm, a width of 40 mm and a thickness of 1.6 mm was used, and lead (KSD 6704) including 2 to 3% of silver was used as solder.

Referring to Table 1, it was confirmed that, in the case in which the recesses R1 and R2 are not formed in the external electrodes 410 and 420 in the coil component of the same structure and the case in which the recesses R1 and R2 are formed, adhesion strength when mounted on the PCB increased by 21.97% at average, from 7.778N to 9.487N.

According to the aforementioned example embodiments, a coil component having a reduced thickness and an external electrode disposed only on the lower surface may be implemented, and processes may be simplified, such that a defect rate between processes may be reduced.

Also, since adhesion strength is strengthened when the coil component is mounted on the PCB, a floating defect in which the coil component moves or rotates may be reduced.

While the example embodiments have been illustrated and described above, it will be apparent to those skilled in the art that modifications and variations could be made without departing from the scope of the present disclosure as defined by the appended claims.

What is claimed is:

1. A coil component, comprising:
a body;
a coil disposed in the body;
an external electrode disposed on one surface of the body and including at least one recess; and
a via electrode disposed in the body and connecting the coil to the external electrode.

2. The coil component of claim 1, wherein a cross-sectional area of the via electrode decreases from an external side to an internal side of the body.

3. The coil component of claim 1,
wherein the body includes a first surface and a second surface opposing each other in a first direction, and a third surface and a fourth surface opposing each other in a second direction perpendicular to the first direction, and
wherein the via electrode is disposed nearer to the third surface than to the fourth surface.

4. The coil component of claim 1,
wherein the external electrode includes an internal side surface facing the body, and an external side surface opposing the internal side surface, and
wherein the at least one recess is disposed in a region of the external side surface opposing a region in which the internal side surface is in contact with the via electrode.

5. The coil component of claim 1, wherein the external electrode and the via electrode are integrally formed.

6. The coil component of claim 1, further comprising:
a pole portion disposed in the body, connected to the external electrode, and spaced apart from the coil and the via electrode.

7. The coil component of claim 6,
wherein the external electrode includes an internal side surface facing the body, and an external side surface opposing the internal side surface, and
wherein the at least one recess is disposed in a region of the external side surface opposing a region in which the internal side surface is in contact with the pole portion.

8. The coil component of claim 6, wherein the external electrode and the pole portion are integrally formed.

9. The coil component of claim 1, wherein a cross-sectional area of the recess decreases from an external side to an internal side of the external electrode.

10. The coil component of claim 1, further comprising:
a support member disposed in the body and supporting the coil.

11. The coil component of claim 10, wherein the coil includes a first coil pattern disposed on one surface of the support member, a second coil pattern disposed on the other surface of the support member, a first via connecting the first and second coil patterns to each other, and first and second lead-out pads extending from ends of outermost turns of the first and second coil patterns, respectively.

12. The coil component of claim 11,
wherein the external electrode includes first and second external electrodes disposed on one surface of the body and spaced apart from each other, and
wherein the via electrode includes a first via electrode connecting the first lead-out pad to the first external electrode, and a second via electrode connecting the second lead-out pad to the second external electrode.

13. The coil component of claim 12, wherein the second via electrode penetrates through the support member and is connected to the second lead-out pad.

14. The coil component of claim 12, wherein the coil further includes a connection pad spaced apart from the first coil pattern on one surface of the support member and connected to the second via electrode, and a second via connecting the second lead-out pad to the connection pad.

15. The coil component of claim 14, wherein, in the first coil pattern, a region adjacent to the connection pad is curved toward a center of the first coil pattern.

16. The coil component of claim 13, wherein the second via electrode is directly connected to the second lead-out pad.

17. The coil component of claim 3, further comprising:
a pole portion disposed in the body, connected to the external electrode, and spaced apart from the coil and the via electrode, wherein the pole portion is disposed nearer to the fourth surface than to the third surface.

18. The coil component of claim 1, wherein the external electrode includes at least two recesses.

19. The coil component of claim 1, wherein the external electrode includes only two recesses.

20. The coil component of claim 1, wherein the external electrode includes a single recess.
